(19) United States
(12) Patent Application Publication
(10) Pub. No.: US 2018/0012264 A1
(43) Pub. Date: Jan. 11, 2018

(54) CUSTOM FEATURES FOR THIRD PARTY SYSTEMS

(71) Applicant: Facebook, Inc., Menlo Park, CA (US)

(72) Inventors: Andrew Donald Yates, San Francisco, CA (US); Gunjit Singh, San Francisco, CA (US); Ramnik Arora, Palo Alto, CA (US)

(21) Appl. No.: 15/206,211

(22) Filed: Jul. 8, 2016

(51) Int. Cl. G06Q 30/02

(52) U.S. Cl. CPC G06Q 30/0275; G06Q 30/0247

(57) ABSTRACT

An online system manages a set of custom features for a third party system stored in user profiles. The online system accesses predictors for the third party system based on the set of custom features for the third party system, the predictors generating predictions for users to the third party system based on the custom features of a lifetime expected incremental value to the third party system from presenting the sponsored content item to the target user. The online system receives from the third party system, data elements for a target user, the data elements related to the actions performed by the target user. The online system extracts custom features from the data elements based on a custom feature definition associated with the third party system. The online system determines a value score for the target user based on the extracted custom features for the target user using the predictors.

### BACKGROUND

This disclosure relates generally to online systems, and in particular to generating custom features for third party systems to determine benefit of a user to the third party system.

Certain online systems, such as social networking systems, allow their users to connect to and to communicate with other online system users. Users may create profiles on such an online system that are tied to their identities and include information about the users, such as interests and demographic information. The users may be individuals or entities such as corporations or charities. Because of the increasing popularity of these types of online systems and the increasing amount of user-specific information maintained by such online systems, an online system provides an ideal forum for third parties to increase awareness about products or services to online system users.

However, it is difficult for a third party system or the online system to accurately predict the LIKELIHOOD of events by a user or to determine the benefit to the third party system of providing a user with content of the third party, such as the LIKELIHOOD that the user will take a desired action related to the content. Thus, it is difficult to determine how much the third party system should pay to provide content to a given user. For example, the online system may determine the benefit of a user to a third party system similarly for all third party systems, and so this determination is not specific to any one particular third party system.

### SUMMARY

Embodiments of the invention include an online system for generating custom features for third party systems to determine benefit of a user to the third party system.

In one embodiment, an online system manages a set of custom features specific to a third party system stored in user profiles of users of the online system. These custom features are provided by the third party systems and includes data about users of the online systems. This data may have been gathered by the third party systems when the users used services, such as a website, of the third party system.

The online system receives from the third party system, data elements for a target user of the plurality of users. The data elements are related to the actions performed by the target user in relation to the third party system. The online system extracts custom features for the target user from the data elements based on a custom feature definition associated with the third party system. Each data element of the data elements may indicate details about the action performed by the target user at the third party system.

The online system stores the extracted custom features in a user profile of the target user. Within each user profile, the extracted custom features are associated with the third party system. Each user profile includes one or more sets of custom features corresponding the third party systems.

The online system subsequently identifies an impression opportunity to present a sponsored content item to the target user. The online system accesses one or more predictors for the third party system to generate a prediction of the expected lifetime incremental value (i.e., increased value) to the third party system for showing a sponsored content to the target user.

The prediction is based on the custom features for the target user in the user profile of the target user. In one case, each predictor uses a logistic regression model to generate the prediction based on the custom features, the custom features being independent variables of the logistic regression model, and the prediction being a dependent variable of the logistic regression model. The event desired by the third party system may be a conversion by the target user

The online system determines a value score for the target user based on the extracted custom features for the target user using the one or more predictors, and determines a bid value for presenting the sponsored content item of the third party system to the target user based on the value score. The online system provides the bid value for the sponsored content item in a content auction, the sponsored content item considered relative to other content items in the content auction for presentation to the target user.

To compute the bid value, the online system may compute the bid value based on an effective cost per mile for the target user, the effective cost per mile based on estimated values of actions performed by the user for being presented with the sponsored content from the third party system, and modify the bid value based on the value score generated by the one or more predictors associated with the third party system

The online system, in response to determining that the bid value for the third party system is a winning bid for the impression opportunity, may provide the sponsored content item from the third party system for display to the target user.

Using such a method, the online system is able to better predict the value provided to a third party system by a target user. By determining the value based on the custom features for the target user, the online system is able to provide the third party system with a better estimation of the value of the target user to the third party system such that the third party system is able to make a more accurate decision regarding the target user.

### BRIEF DESCRIPTION OF THE DRAWINGS

FIG. 1 is a high level block diagram of a system environment for an online system, according to an embodiment.

FIG. 2 is an example block diagram of an architecture of the online system, according to an embodiment.

FIG. 3 is a block diagram illustrating an exemplary data flow of custom data from a third party system used to generate a prediction indicating a benefit provided to a third party system by a target user.

FIG. 4 is a flowchart of one embodiment of a method in an online system for predicting a benefit to a third party system using custom features.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

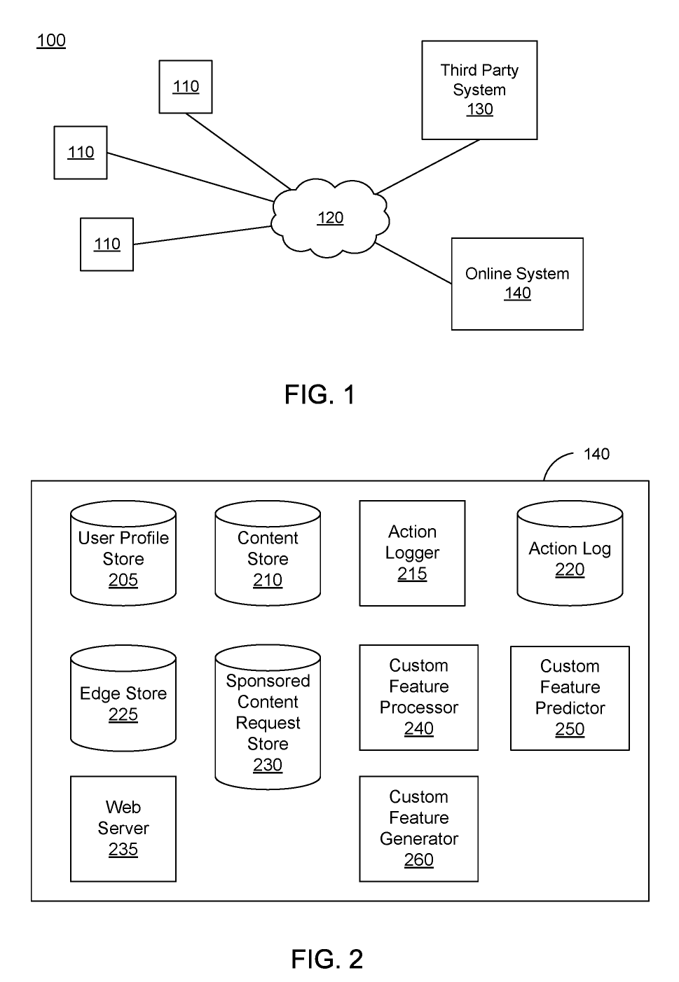

FIG. 1 is a high level block diagram of a system environment 100 for an online system 140 for generating custom features for third party systems to determine benefit of a user to the third party system, according to an embodiment. The system environment 100 shown by FIG. 1 comprises one or more client devices 110, a network 120, one or more third-party systems 130, and the online system 140. In alternative configurations, different and/or additional components may be included in the system environment 100. In one embodiment, the online system 140 is a social networking system.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130, such as a sponsored content provider system, may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130. Specifically, in one embodiment, a third party system 130 communicates sponsored content, such as advertisements, to the online system 140 for display to users of the client devices 110. The sponsored content may be created by the entity that owns the third party system 130. Such an entity may be an advertiser or a company producing a product, service, message, or something else that the company wishes to promote.

FIG. 2 is an example block diagram of an architecture of the online system 140, according to an embodiment. The online system 140 shown in FIG. 2 includes a user profile store 205, a content store 210, an action logger 215, an action log 220, an edge store 225, a sponsored content request store 230, a web server 235, a custom feature processor 240, a custom feature predictor 250, and a custom feature generator 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

In one embodiment, the user profile store 205 stores custom features for one or more third party systems. Sets of custom features may be associated with each user and represent information and other data that may be used in a model to make a prediction regarding the benefit (e.g., monetary benefit, return on investment, number of clicks, time spent, number purchases) that providing content to the user may provide to a third party system 130 (e.g., likely conversion or taking of an action related to the content, such as purchasing a product advertised in the content). Each third party system 130 may have its own set of custom features for each different user. Thus, each user may have stored in a corresponding user profile of the user profile store 205 multiple sets of custom features, each set associated with a third party system 130. For example, each user may have a profile with a set of custom features for the user for third party A, a set for third party B, a set for third party C, and so forth. Each third party's own specific features can be used in serving content to the user, including determining the right bid amount of use in an ad auction for serving an ad to that user.

The online system 140 may receive the data represented in each custom feature from the third party system 130 when the event that may generate the data for the custom feature occurs at the third party system 130. For example, this may occur via the use of a tracking pixel that is “fired” on a webpage of the third party system 130 in association with the event when the user browses that page, where third-party specific data about the event is sent to the online system via the fire of the pixel. A tracking pixel may be a segment of HTML code that the online system 140 provides to third party systems 130 for implementation on websites of the third party systems 130. For example, a tracking pixel may be a transparent 1×1 image, an iframe, or other suitable object. When a browser of a client device 110 requests the content of a page having the tracking pixel, the content of the tracking pixel is also requested from the online system 140. The request for the content of the tracking pixel includes information about the client device 110 and the browser, such as the Internet Protocol (IP) address of the client device 110, and cookies the online system 140 may have set in the browser of the client device 110.

Alternatively, the online system 140 may receive the custom feature data in batches from the third party system 130 (e.g., on a regular schedule, after a certain amount of data is gathered, after a user action reaches a threshold or milestone on the third party system 130), or otherwise asynchronously using an API of the online system 140. This information may not necessarily be related to an action, for example, the information may be information purchased by the third party system 130 from a vendor. As another alternative, the online system 140 may generate the custom features based on data stored for the third party system 130 (e.g., in an action log).

These custom features may represent any type of data in any format, such as an alphanumeric string, Boolean, enumeration, number, table, binary object, timestamp, and so on. For example, a set of custom features for a third party system 130 that is a travel information provider may include a custom feature indicating each destination search on that travel information provider by the user. When a user makes such a search, a tracking pixel may fire on the third party system 130, and the data for this custom feature may be received by the online system 140. As another example, a custom feature for a third party system 130 that is an educational provider may indicate the last course that was taken by the user. As another example, a custom feature for a third party system 130 that is a retailer may indicate the purchases that have been made by the user.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions are stored in the action log 210. Examples of interactions with objects include: commenting on posts, sharing links, and checking-in to physical locations via a mobile device, accessing content items, and any other interactions. Additional examples of interactions with objects on the online system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website that primarily sells sporting equipment at bargain prices may recognize a user of an online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system, sharing a link with other users of the online system, and commenting on posts made by other users of the online system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The sponsored content request store 230 stores one or more sponsored content requests. Sponsored content is content that an entity (i.e., a sponsored content provider) presents to users of an online system and allows the sponsored content provider to gain public attention for products, services, opinions, causes, or messages and to persuade online system users to take an action regarding the entity's products, services, opinions, or causes. In one embodiment, a sponsored content is an advertisement, and the sponsored content request store 230 stores advertisement requests (“ad requests”). An ad request includes advertisement content, also referred to as an “advertisement” and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser (who may be the entity providing the sponsored content) and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies or is used to compute a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The web server 245 links the online system 140 via the network 120 to the one or more client devices 110, as well as to the one or more third party systems 130. The web server 140 serves web pages, as well as other web-related content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or RIM®.

The custom feature processor 240 generates custom features for a third party system 130. The custom feature processor 240 may extract the custom features from data (“custom data”) received from a third party system 130, or may generate the custom features based on existing data stored by the online system 140 and related to the third party system 130. As noted, the custom features are data that may be used by a model to predict the benefit that a user may provide to a third party system 130. This prediction may involve estimating the lifetime expected increase in benefit to a third party system by presenting a sponsored content of the third party system to the user. That benefit may be a conversion, a time spent, application installs made, a click on the sponsored content, and so on. Useful features are those that maximize the signal (i.e., the prediction accuracy of the benefit) and minimize noise.

The custom feature processor 240 may store for one or more third party systems 130 a definition of the custom features for that third party system 130. The definition of the custom features for a third party system 130 describes the custom features for that third party system, and may include indications of how to transform data (e.g., data elements) received from the third party system 130 or data stored by the online system 140 into the custom features for the third party system 130. For example, one definition for a third party system 130 may define a custom feature indicating the recency of particular transactions performed by a target user at the third party system 130 (i.e., how recent a transaction occurred). The definition may further indicate that the recency may be computed based on the timestamp received from the third party system 130 in a custom data for the transaction.

In one embodiment, the custom feature processor 240 extracts custom features from the custom data received from a third party system 130 for a target user (i.e., a user for which the custom data is related). As noted, the custom data may be received immediately upon the occurrence of an event generating the custom data, or may be received in batch. In some cases, some or all of the custom data may be pre-processed and may already be ready to be used as a custom feature. In such a case, the custom feature processor 240 stores the pre-processed custom data as corresponding custom features in the user profile of the target user.

In another embodiment, the custom feature processor 240 processes the custom data in order to generate a custom feature that matches the definition of the custom feature for that third party system 130. For example, the custom feature processor 240 may process a timestamp to produce a feature indicating a recency of an action of the target user. As another example, the custom feature processor 240 may filter the custom data to remove unnecessary metadata, such as network addresses, technical data, and so on in order to generate a custom feature. These custom feature processor 240 may further process each custom feature to include a numerical representation of that feature (for use in a statistical model). To do this, the custom feature processor 240 may normalize some of the outcomes for each custom feature such that similar outcomes use the same numerical representation. For example, if a custom feature is a search term, the custom feature processor 240 may recognize that certain search terms are similar or are synonyms of each other and represent both using the same numerical representation.

In one embodiment, the custom feature processor 240 generates the custom features based on information stored at the online system 140 about the third party system 130 and about the target user. This information may have been previously received from the third party system 130.

In one case, this information may indicate a measure of similarity between the target user and other users of the online system 140. This measure of similarity may be determined by the online system 140 based on a percentage of characteristics of the target user (e.g., characteristics stored in the user profile of the target user) shared with another group of users. Additional details regarding determining measures of similarity between users of an online system are further described in U.S. patent application Ser. No. 13/297,117, filed on Nov. 15, 2011, U.S. patent application Ser. No. 14/290,355, filed on May. 29, 2014, U.S. patent application Ser. No. 14/719,780, filed on May 22, 2015, all of which are hereby incorporated by reference in their entirety.

The custom feature processor 240 may use the measure of similarity information for the target user and other users or user groups in the online system 140 as a feature that may help to determine the benefit of the target user to the third party system 130. The different users for which the target user has a measure of similarity may each have previously interacted with the third party system 130, and may each have a measure of the benefit made to the third party system 130 (i.e., a numerical or other measure of the benefit). Additionally, the other users for which the target user has a measure of similarity may themselves also have custom features for the third party system 130. The custom feature processor 240 may generate custom features for the target user based on the measures of similarity between the target user and the other users in the online system 140, and may also include as custom features the measured benefit for the third party system 130 for the other users, and/or the custom features (or a statistical aggregation of the custom features) for the other users.

The custom feature processor 240 may also generate additional custom features based on information stored by the online system 140 that is specific to the third party system 130. This information may include information regarding the third party system 130 such as profile information, location information (e.g., location of the organization of the third party system 130), type of business, demographics of users of the third party system 130, and other information that may be specific to the third party system 130 and not necessarily generally applicable to other third party systems. The custom feature processor 240 may process this information into a standardized format (e.g., address information may be standardized).

The custom feature processor 240 may also generate custom features based on targeting segments of users that have been specified by the third party system 130. The targeting segments of users may be specified by the third party system 130 using targeting criteria, business rules, and other information. Business rules are various criteria that specify users (e.g., a business rule may have a criteria specifying users who have recently visited a third party system's website within the past X hours). Methods of identifying users by a third party system are further described in U.S. patent application Ser. No. 13/306,901, filed on Nov. 29, 2011, U.S. patent application Ser. No. 14/034,350, filed on Sep. 23, 2013, U.S. patent application Ser. No. 14/177,300, filed on Feb. 11, 2014, and U.S. patent application Ser. No. 14/498,894, filed on Sep. 26, 2014, all of which are hereby incorporated by reference in their entirety.

The custom feature processor 240 may generate custom features based on the targeting segments for which the target user is a member. These custom features may describe the targeting segments, including the number of users within each, the criteria used to select each targeting segment, and so on. The custom feature processor 240 may also generate custom features based on the custom features, profile information, connections, or other attributes of other users in the targeting segments for which the target user is a member. As the targeting segments are specific to each third party system 130, the information regarding the targeting segments and the target user's membership in each may provide valuable information for predicting the benefit the user may provide to the third party system 130.

The custom feature predictor 250 generates a prediction indicating the benefit that a target user may provide to a third party system 130 using the custom features for that third party system 130. The custom feature predictor 250 may also utilize other more standardized information stored by the online system 140 that is not specific to the particular third party system 130.

In particular, this benefit may indicate the lifetime expected incremental value to the third party system after showing or as a result of the sponsored content of the third party content to the target user. The custom feature predictor 250 may approximate or estimate this value through a combination of various factors. For example, the custom feature predictor 250 may use the value provided by the third party system 130, and/or the value determined by the online system 140 for the user, e.g., by measuring engagement of the target user with the third party system, which may be negative. Additional methods used by the online system 140 to measure this value may include estimating a click within a period of time, estimating a post-click conversion within a period of time hours, or multiplying these event probabilities by the estimated value of the event, which itself can be an estimate.

The value that is estimated may be used to inform which sponsored content items are selected, and where they may be placed to be presented to the target user. The value may be used to inform upon the compensation that is to be requested from the third party system 130 from the auction. Additionally, as noted below, the prediction of this value may be influenced by the various custom features from the third party system 130.

In one embodiment, the custom feature predictor 250 is trained using custom features generated by the custom feature processor 240 as described above, but using prior custom data and other information stored by the online system 140. In one embodiment, the custom feature predictor 250 is additionally trained continuously using real time custom features generated by the custom feature processor 240 using custom data and other information that is received by the online system 140 in real time.

The labeled output data upon which the custom feature predictor 250 is trained may be based on a measure of the benefit to the third party system 130 of the user with which the custom features are associated. For example, if the benefit to the third party system 130 is a conversion rate (i.e., rate at which users perform a desired action upon presentation of an initial content), then the output values for the training data are the conversion rate(s) of a training set of users, and the inputs for the training data are the custom features associated with those users. An example of a custom feature in this training data may be a search term for a search made by the training set of users on a website of the third party system 130. Although other custom features would most likely need to be used to make an accurate prediction of the benefit to the third party system, in considering each search term custom feature in isolation, the custom feature predictor 250 may predict that certain search terms may result in higher conversion rates for the third party system based on this training data.

In one embodiment, the custom feature predictor 250 uses logistic regression to model the prediction based on the custom features and training output data. Logistic regression measures the relationship between a categorical dependent variable and one or more independent variables by estimating probabilities using a logistic function (which may be represented by a sigmoid curve). The custom feature predictor 250 uses logistic regression to generate the prediction based on the custom features. The custom feature predictor 250 may code the custom features into various numerical representations, and use these representations as the independent variables of the logistic regression model. The benefit may be coded as the dependent variable, and thus the prediction made by the model may estimate the occurrence of the benefit.

For example, if a custom feature for a third party system 130 includes a search term, the custom feature predictor 250 may receive custom features from the custom feature processor 240 that include numerical representations of the search terms made by a user. The custom feature predictor 250 may then be able to use a previously trained logistic regression model to predict a benefit such as a user making a purchase on the third party system 130 using this custom feature as a dependent variable, as well as other dependent variables (e.g., recency, etc.). The logistic regression model for this case was previously trained by the custom feature predictor 250 using past data, in a fashion similar to the training method described above.

In other embodiments, other statistical and/or machine learning methods may be used as the model for the predictor. For example, the custom feature predictor 250 may use a perceptron model, a neural network, a Bayesian network, and so on. These models may be similarly trained using prior data and the output data as described above. The custom feature predictor 250 may further use new data received from the third party system 130 regarding the benefit provided by users to determine the accuracy of the predictions of each model (i.e., how well the model's predictions match the actual result of the benefit provided). The custom feature predictor 250 may then use the model with the most accurate predictions, or weigh the result of each model according to its accuracy. For example, if the benefit to be provided by a user is a conversion (e.g., a purchase) for the third party system 130, then the accuracy of a model may depend on how well it can predict the of a conversion.

In one embodiment, the custom feature generator 260 automatically generates the definitions of custom features for a third party system 130. While the definition of a custom feature can be generated manually or semi-manually, the custom feature generator 260 may instead automatically generate definitions for useful custom features that may be significant in predicting a particular benefit to the third party system 130.

The online system 140 receives a large amount of data from the third party system 130 (e.g., custom data, conversion information, the industry for each third party system), from users of the online system 140 (e.g., profile information), and from other sources (e.g., other third party systems, informational databases). The custom feature generator 260 may define custom features from this received data. The custom feature generator 260 may generate a definition based on fitting this data to a model, based on various data transforms, based on the targeting segment data received from the third party system 130, based on an analysis of the user profile information data received from users, and so on.

In one embodiment, the custom feature generator 260 generates definitions of custom features based on fitting the received data to a model. The custom feature generator 260 may take various elements from this received data, and fit these elements to a model, such as the logistic regression model described above, or some other model (e.g., a polynomial regression model). If an element added as an independent variable to the model changes the parameters of the model beyond a certain threshold, this element may be used as a custom feature. Additionally, the custom feature generator 260 may check the weights of each data element and exclude those with low weights.

For example, the custom feature generator 260 may determine whether a custom data from a third party system 130 indicating a location of a user access to the third party system 130 is useful as a custom feature for the third party system 130. The custom feature generator 260 may add this data as a custom feature into a regression model for the third party system 130 that is intended to predict a benefit of that user to the third party system 130. For example, the benefit may be whether a user purchases a particular travel package. The custom feature generator 260 may determine that the location of the user, when used as a custom feature, does improve the prediction ability of the regression model beyond a certain threshold. The custom feature generator 260 determines this improvement by applying the updated model to prior data that includes information about travel packages purchased by users. On the other hand, for example, if the benefit for another third party system is the purchase of a software application, the location of the user may not impact the prediction of the of the purchase, and so the location of the user may not be used as a custom feature to determine this benefit for this other third party system.

In one embodiment, the custom feature generator 260 also applies various transforms to the received data so that the data may be used as a custom feature. In particular, the custom feature generator 260 attempts to convert received data with high sparsity to data with lower sparsity. Data with high sparsity is data that is separated into a large number of categories which do not repeat often. For example, data stored by the online system 140 for users may include the postal codes for users. However, as a large number of postal codes exist, this data may be sparse, as there may only be a few number of users per postal code. The custom feature generator 260 may transform this data set such that users within geographically neighboring postal codes are categorized into a single identifier. This reduces the categories for the data set and makes it more useful as a potential custom feature. As another example, a user profile may include various preferences for a user, such as a user's media preferences (e.g., which movies the user likes). These media preferences may identify a large number of media items, media creators, and so on. The custom feature generator 260 may transform this data by reducing the number of categories represented in this data by grouping the various identified media items into genres (e.g., action movies, country songs), regions (movies from Europe, songs from the Midwest), and so on.

In one embodiment, the custom feature generator 260 uses machine learning dimensionality reduction techniques to reduce the number of “categories” or “dimensions” of the received data. The methods used may include supervised methods (e.g., supervised linear embeddings) and unsupervised methods (e.g., co-occurrence clustering, methods including stochastic block modeling, K-means, hierarchical clustering, etc.)

The custom feature generator 260 may also transform other common data into more useful formats for use as a custom feature. In one embodiment, the custom feature generator 260 transforms timestamp data into recency data or duration data. For example, the custom feature generator 260 may convert a timestamp to recency information by subtracting the current time from the timestamp data. The custom feature generator 260 may also ensure that categories in data can be uniquely identified by assigning a unique identifier to each data element. Users or third party systems 130 may provide data that identifies the same entity, but may be structured differently. For example, one city may be identified using various nicknames. The custom feature generator 260 may transform this data into a single unique identifier.

The custom feature generator 260 may also apply other mathematical transforms to data stored or received by the online system 140 for use as a custom feature. For example, the custom feature generator 260 may apply a log transform to data that has an exponential distribution. The custom feature generator 260 may perform a polynomial expansion on data. Other types of mathematical transforms or other transforms may also be applied to data by the custom feature generator 260.

In one embodiment, the custom feature generator 260 uses targeting segments for the third party system 130 to generate definitions of custom features. The custom feature generator 260 may track the statistics of users identified in each targeting segment, including the benefit that each user has provided to the third party system 130. This might include a number of clicks, number of conversions, and so on, that the users in each targeting segment have provided. The custom feature generator 260 may also determine the measure of similarity between users of different targeting segments. The custom feature generator 260 may generate a definition of a custom feature that identifies multiple targeting segments sharing similar statistics or similar users as a single segment for the purposes of using this identifier as a custom feature.

In one embodiment, the custom feature generator 260 uses data not specifically related to the third party system 130 or the event that caused the custom data to be generated from the third party system 130 to define a custom feature. This data may be “vertical” information, or in other words, it is data related generally to the third party system 130 but not directly received from the third party system 130. This may be data related to the area of focus in which the third party system 130 practices (e.g., software industry, online streaming industry), or information stored by the online system 140 regarding the third party system 130 (e.g., users who have expressed interest in the third party system). The custom feature generator 260 may determine whether this data is useful for predicting a benefit (e.g., by using the method described above), and use this data to define a custom feature.

In another embodiment, the custom feature generator 260 may generate features from the data received from third party system 130 by aggregating how that information changes over time, e.g., using a mean, sum, last N most recent values, deviation, difference from the last value, etc.

In another embodiment, the custom feature generator 260 may generate features from the data received from third party systems 130 by combining the data with data from the online system 140 systematically in order to form new features. The custom feature generator 260 may learn about different actions of users using methods like neural networks, gradient boosting (GBDT) (e.g., if a third party system has a value A for one user, use value X from the online system, else use value Y from the online system), or dimensionality reduction techniques using data within the dimensional space of both the online system and the third party system.

Using such a system as described above, an online system 140 may be able to better determine whether a user of the online system 140 is likely to provide a benefit to a third party system 130. This may be useful when a third party system 130 is interested in providing a sponsored content to a user of the online system 140. When such an impression opportunity arises to present sponsored content to the target user of the online system 140, the online system 140 may compute a bid value based on a prediction of the benefit that the target user may provide to the third party system 130, with the prediction made using the custom features as described above. By using the custom features, the bid value may more accurately reflect a potential benefit that the user may provide to the third party system 130 if presented with the sponsored content. This allows the online system 140 to better rank users and to provide better value to third party systems 130 using the online system 140 to provide promotional or other messages to users of the online system 140. Using this system, the third party system 130 may not need to target groups of users individually, and may instead rely upon the online system 140 to provide predict an accurate benefit provided by each user and to allow the online system 140 to determine a bid value accordingly.

Exemplary Block Diagram of Data Flow Illustrating the Prediction of a Benefit to a Third Party System using Custom Features

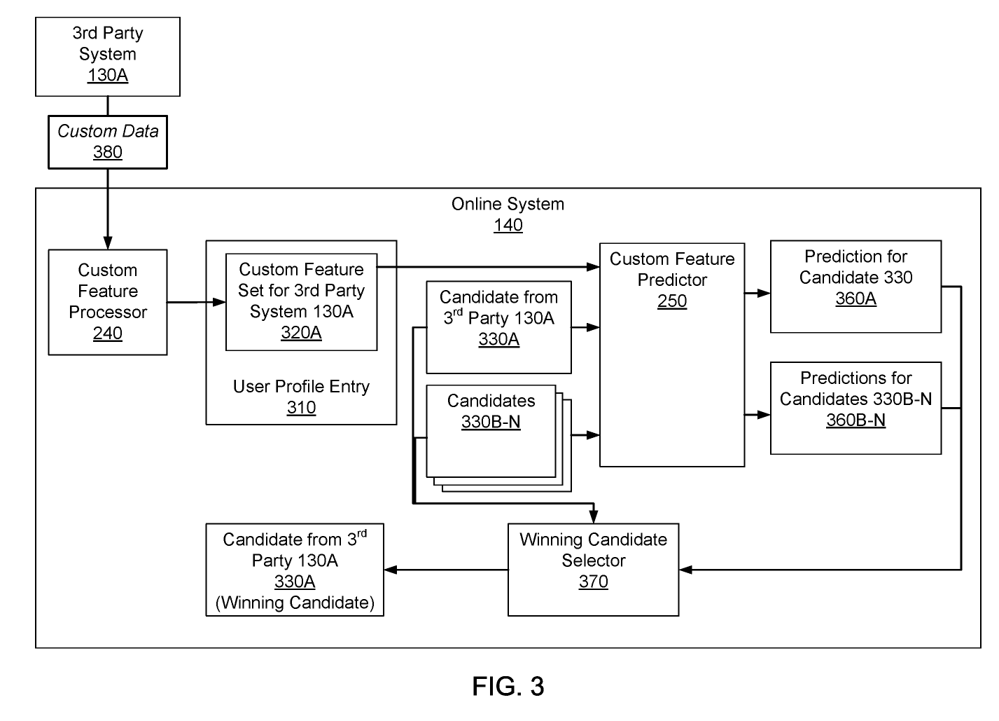

FIG. 3 is a block diagram illustrating an exemplary data flow of custom data from a third party system used to generate a prediction indicating a benefit provided to a third party system by a target user. Although certain elements are illustrated in FIG. 3, in other embodiments the elements may be different and the flow of the data through the elements may be different.

Initially, a target user accesses the third party system 130A. The target user may perform some action at the third party system 130A resulting in an event, or an event may occur at the third party system 130A related to the target user. Upon the occurrence of the event, the third party system 130A may generate the custom data 380 based on the event, and the third party system 130A may send the custom data 380 to the online system 140. This custom data may be in any format (e.g., binary, text) and may indicate the details regarding the actions performed by the target user at the third party system. In one embodiment, the online system 140 includes a tracking pixel or other indicator at the third party system 130A that includes instructions that are executed upon the occurrence of the event. These instructions cause the online system 140 to receive the custom data 380 from the third party system 130A.

The custom data 380 is processed by the custom feature processor 240 to generate custom features 320A for the third party system 130A for the target user. These custom features 320A are stored in the user profile entry 310 for the target user. In one embodiment, the custom features 320A are stored as key-value entries. In one embodiment, the custom feature processor 240 processes the custom data 380 is in accordance with the method described above with reference to FIG. 2. As an example, assume the third party system 130A is a retailer. In such an example, the custom data may include information about the last product search made by the target user, whether the user purchased the item, an associated timestamp, and so on. The custom feature processor 240 may generate the custom features 320A based on the definitions of the custom features 320A for the third party system 130A. For example, the custom feature processor 240 may convert the timestamp into a recency value to be used as a custom feature 320A. The custom feature processor 240 may transform the product search data into one of a set list of categories of products.

Other custom features may also be defined for the third party system 130A based on other custom data 380 that is received by the online system 140, as well as information stored by the online system 140, such as the targeting segments for the third party system 130A. For example, the custom feature processor 240 may generate a custom feature (based on a definition of the custom feature) that is based on the targeting segment to which the target user belongs, in a similar manner to the method described above. For example, the third party system 130A may have previously indicated a targeting segment of users of a certain demographic (e.g., 18-30 years old, indicated preference for gadgets) for which the user belongs. The custom feature processor 240 may indicate this targeting segment as a custom feature.

At some point, an impression opportunity is identified by the online system 140 for the target user. An impression opportunity is an opportunity for (or event in which) the online system 140 to present an impression of a sponsored content from a third party system 130 to the target user. This may occur when the target user accesses the online system 140 via a client device 110 (e.g., via a website of the online system 140). When the online system 140 identifies the impression opportunity, the online system 140 identifies one or more candidates 330 for the impression opportunity. These candidates may each be or identify a sponsored content (e.g., from the sponsored content request store 230) and may have been identified by the online system 140 based on the respective targeting criteria for each candidate 330. The candidates may include the candidates 330B-N from other third party systems 130B-N and the candidate 330A for third party system 130A.

The custom feature predictor 250 generates predictions 360 for each of the candidates 330 in order to predict the benefit that the target user would provide to the third party system 130 associated with each candidate 330. In the case of the candidate 330A, the custom feature predictor 250 determines that this candidate corresponds to third party system 130A, and retrieves the custom feature data set 320A for the third party system 130A. The custom feature predictor 250 uses the custom feature data set 320A to generate a prediction for the third party system 130A in regards to the target user. The custom feature predictor 250 may use the model for the third party system 130A, and may generate a prediction using a method similar to that described above for FIG. 2. The prediction 360A that is generated indicates an estimation that the target user may provide a benefit to the third party system 130A in response to being presented with a sponsored content from the third party system. For example, the prediction may be of a conversion event for that target user.

For the other candidates 330B-N, the custom feature predictor 250 determines the corresponding third party candidate 130B-N and determines whether a corresponding custom feature data set 320B-N (not shown) exists for that third party system 130 for that target user in the user profile entry 310 for the target user. If no corresponding custom feature set exists, then the custom feature predictor 250 may output a default prediction for the corresponding candidate indicating no prediction is made (e.g., a null prediction may be made). In one embodiment, the online system 140 includes more than one custom feature predictor 250. For example, one custom feature predictor 250 may be used for each third party system 130 or group of third party systems 130. As another example, a custom feature predictor 250 may be used for each prediction model, and multiple third party systems 130 may be associated with the same model.

The winning candidate selector 370 determines the winning candidate 330 to be presented to the target user. In one embodiment, the winning candidate selector 370 determines individual bid values, such as a click bid value (eCTR), a conversion bid value (eCVR), and a negative feedback bid value (eNFB), and combines these into a eCPM (effective cost per mile) bid value. The individual bid values (representing the values for performing certain actions, such as a click) or the combined eCPM bid value may be modified based on the prediction 360 by the custom feature predictor 250. For example, if the custom feature predictor 250 predicts a low estimate of a benefit occurring for a third party system 130 for the target user, the bid value may be lowered in proportion. On the other hand, the bid value may be increased if the custom feature predictor 250 predicts a high estimation of a benefit occurring. The bid value may also be influenced by an average bid value set by each third party system 130. The online system 140 may adjust the bid value so that an average of the recent bid values within a time window approaches the average bid value set by the respective third party system 130.

Additional details regarding determining bid amounts are further described, for example, in U.S. patent application Ser. No. 14/160,510, filed Jan. 21, 2014, which is hereby incorporated by reference in its entirety.

Once the bid value is determined for each candidate 330, the candidate with the winning (e.g., highest) bid value is selected as the winning candidate, and is presented to the target user in the impression opportunity. The selection of the candidate and presentation of the candidate to the target user may be performed completely in real-time, with the delay to the user between the identification of the impression opportunity and the presentation of the sponsored content to be very small (e.g., under 100 milliseconds). By performing the candidate selection and presentation in real time (or near real-time), the online system 140 is able to utilize the most up to date custom feature information for each user. In the illustrated example of FIG. 3, candidate 330A is the winning candidate.

Note that although the winning candidate selector 370 is described here as receiving the predictions 360 and using the predictions 360 to modify the computed bid value, in other embodiments the online system 140 computes a bid value for each candidate 330 and the custom feature predictor 250 modifies the bid value using the generated predictions 360 and outputs a bid value for each candidate 330 and/or the winning candidate 330.

Exemplary Flow of a Method of Predicting a Benefit to a Third Party System using Custom Features

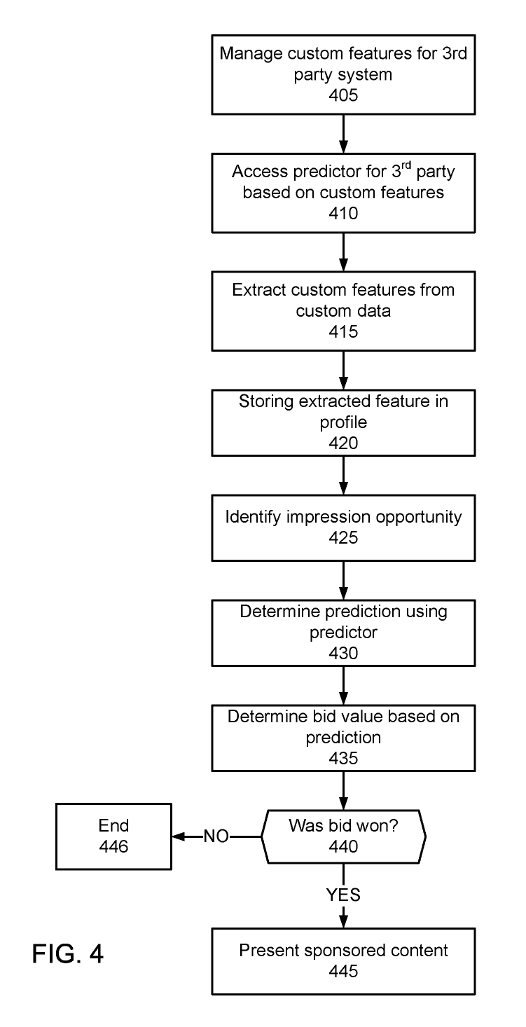

FIG. 4 is a flowchart of one embodiment of a method in an online system for predicting a benefit to a third party system using custom features. In other embodiments, the method may include different and/or additional steps than those described in conjunction with FIG. 4. Additionally, in some embodiments, the method may perform the steps described in conjunction with FIG. 4 in different orders. In one embodiment, the method is performed by one or more of the modules of the online system 140 as described above.

The online system 140 manages 405 the custom features for a third party system. As described above, these custom features may be features related to actions performed by users in the third party system, and may be provided directly by the third party system, or may be generated by the online system 140 (e.g., with the custom feature generator 260) based on data received from the third party system (e.g., the custom data). The custom features may be stored in user profile entries in the online system 140 as described above.

The online system 140 accesses 410 predictor(s) for the third party system based on the custom features. The predictor (e.g., the custom feature predictor 250) can make a prediction of a benefit (e.g., a conversion) made to the third party system by the user. The predictor makes this prediction based on the information from the custom features, as described above.

The online system 140 (e.g., the custom feature generator 260) extracts 415 the custom features from the custom data received from the third party system. The custom data is data that may be specific or related to some event or activity performed by the user at the third party system. For example, the online system 140 may extract a recency feature based on a timestamp received from the third party system in the custom data.

The online system 140 stores 420 the extracted feature(s) in the user profile of the corresponding user. As noted above, the custom features (i.e., the specific value of the custom feature) may be unique to each user, and thus the online system 140 may store the features within the user profile of each corresponding user.

The online system 140 identifies 425 an impression opportunity for a user. This is an opportunity to present a content item to the user. For example, the user (i.e., the client device of the user) may have requested a web page from the online system 140 upon which an impression opportunity exists.

The online system 140 determines 430 a prediction for the user using the predictor for the third party system. As noted above, each third party system may have a separate predictor, or multiple third party systems may share a predictor. The predictor determines an estimation that a benefit to the third party system will be generated based on the custom features for a user.

The online system 140 determines 435 a bid value for the user based on the prediction value. As described above, the online system 140 may calculate an eCPM value, and may modify this value using the results of the prediction.

If the bid is won 440, then the online system 140 presents 445 the sponsored content for the third party system (which won the bid) to the user. Otherwise, the process ends and the sponsored content item for that third party system is not presented. However, this does not mean that no sponsored content is presented to the user. In such a case, another bid value for another sponsored content for another third party system will have won the bid, and that sponsored content for the other third party system is presented to the user instead.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
managing, by an online system, a set of custom features specific to a third party system stored in a plurality of user profiles of a plurality of users of the online system;
receiving, by the online system from the third party system, one or more data elements for a target user of the plurality of users, the data elements related to the actions performed by the target user in relation to the third party system;
extracting one or more custom features for the target user from the data elements based on a custom feature definition associated with the third party system;
storing the extracted custom features in a user profile of the target user, each custom feature associated with the third party system;
identifying an impression opportunity to present a sponsored content item to the target user;
accessing one or more predictors for the third party system to generate a prediction of a lifetime expected incremental value to the third party system as a result of presenting the sponsored content item to the target user, the prediction based on the custom features for the target user in the user profile of the target user;
determining a value score for the target user based on the extracted custom features for the target user using the one or more predictors;
determining a bid value for presenting the sponsored content item of the third party system to the target user based on the value score; and
providing the bid value for the sponsored content item in a content auction, the sponsored content item considered relative to other content items in the content auction for presentation to the target user.

2. The method of claim 1, wherein each predictor uses a logistic regression model to generate the prediction based on the custom features, the custom features being independent variables of the logistic regression model, and the prediction being a dependent variable of the logistic regression model.

3. The method of claim 1, wherein each user profile of the plurality of user profiles includes one or more sets of custom features corresponding to one or more third party systems.

4. The method of claim 1, wherein the lifetime expected incremental value is predicted based on measuring engagement of the target user with the third party system.

5. The method of claim 1, wherein each data element of the data elements indicates details about the action performed by the target user at the third party system.

6. The method of claim 1, wherein the extracting one or more custom features further comprises:
accessing one or more custom feature definitions for the third party system, each custom feature definition indicating transformations to apply to the data elements received from the third party system to generate the custom features for the third party system; and
generating the custom features based on the data elements using the custom feature definitions.

7. The method of claim 1, wherein the determining a value score for the target user based on the extracted custom features further comprises:
inputting the extracted custom features into the one or more predictors for the third party system;
using the one or more predictors to generate one or more predictions estimating the lifetime expected incremental value of the target user; and
generating the value score based on the one or more predictions.

8. The method of claim 1, wherein the determining a bid value for the third party system further comprises:
computing the bid value based on an effective cost per mile for the target user, the effective cost per mile based on estimated values of actions performed by the user for being presented with the sponsored content from the third party system; and
modifying the bid value based on the value score generated by the one or more predictors associated with the third party system.

9. The method of claim 1, further comprising:
for each additional third party system, determining a value score for the target user for the additional third party system based on the extracted custom features for the target user for the additional third party system using the one or more predictors associated with the additional third party system; and
determining a bid value for each additional third party system based on the value score corresponding to each additional third party system.

10. The method of claim 1, further comprising:
in response to determining that the bid value for the third party system is a winning bid for the impression opportunity, providing the sponsored content item from the third party system for display to the target user.

11. A computer program product comprising a non-transitory computer readable storage medium having instructions encoded thereon that, when executed by a processor, cause the processor to:
manage, by an online system, a set of custom features specific to a third party system stored in a plurality of user profiles of a plurality of users of the online system;
receive, by the online system from the third party system, one or more data elements for a target user of the plurality of users, the data elements related to the actions performed by the target user in relation to the third party system;
extract one or more custom features for the target user from the data elements based on a custom feature definition associated with the third party system;
store the extracted custom features in a user profile of the target user, each custom feature associated with the third party system;
identify an impression opportunity to present a sponsored content item to the target user;
access one or more predictors for the third party system to generate a prediction of a lifetime expected incremental value to the third party system as a result of presenting the sponsored content item to the target user, the prediction based on the custom features for the target user in the user profile of the target user;
determine a value score for the target user based on the extracted custom features for the target user using the one or more predictors;
determine a bid value for presenting the sponsored content item of the third party system to the target user based on the value score; and
provide the bid value for the sponsored content item in a content auction, the sponsored content item considered relative to other content items in the content auction for presentation to the target user.

12. The computer program product of claim 11, wherein each predictor uses a logistic regression model to generate the prediction based on the custom features, the custom features being independent variables of the logistic regression model, and the prediction being a dependent variable of the logistic regression model.

13. The computer program product of claim 11, wherein each user profile of the plurality of user profiles includes one or more sets of custom features corresponding to one or more third party systems.

14. The computer program product of claim 11, wherein the lifetime expected incremental value is predicted based on measuring engagement of the target user with the third party system.

15. The computer program product of claim 11, wherein each data element of the data elements indicates details about the action performed by the target user at the third party system.

16. The computer program product of claim 11, having further instructions encoded thereon that, when executed by the processor, cause the processor to:
access one or more custom feature definitions for the third party system, each custom feature definition indicating transformations to apply to the data elements received from the third party system to generate the custom features for the third party system; and
generate the custom features based on the data elements using the custom feature definitions.

17. The computer program product of claim 11, having further instructions encoded thereon that, when executed by the processor, cause the processor to:
input the extracted custom features into the one or more predictors for the third party system;
use the one or more predictors to generate one or more predictions estimating the lifetime expected incremental value of the target user; and
generate the value score based on the one or more predictions.

18. The computer program product of claim 11, having further instructions encoded thereon that, when executed by the processor, cause the processor to:
compute the bid value based on an effective cost per mile for the target user, the effective cost per mile based on estimated values of actions performed by the user for being presented with the sponsored content from the third party system; and
modify the bid value based on the value score generated by the one or more predictors associated with the third party system.

19. The computer program product of claim 11, having further instructions encoded thereon that, when executed by the processor, cause the processor to:
for each additional third party system, determine a value score for the target user for the additional third party system based on the extracted custom features for the target user for the additional third party system using the one or more predictors associated with the additional third party system; and
determine a bid value for each additional third party system based on the value score corresponding to each additional third party system.

20. The computer program product of claim 11, having further instructions encoded thereon that, when executed by the processor, cause the processor to:
in response to determining that the bid value for the third party system is a winning bid for the impression opportunity, provide the sponsored content item from the third party system for display to the target user.
